(19) United States
(12) Patent Application Publication
(10) Pub. No.: US 2013/0195946 A1
(43) Pub. Date: Aug. 1, 2013

(54) INSECTICIDAL HYDROGEL FEEDING SPHERES

(71) Applicants: Aurora Stamper, Phoenix, AZ (US); Frédérique M. de Lame, Los Angeles, CA (US); Arlana M. Brugato, Scottsdale, AZ (US); Richard K. Merwin, Phoenix, AZ (US); Debra A. Park, Mesa, AZ (US)

(72) Inventors: Aurora Stamper, Phoenix, AZ (US); Frédérique M. de Lame, Los Angeles, CA (US); Arlana M. Brugato, Scottsdale, AZ (US); Richard K. Merwin, Phoenix, AZ (US); Debra A. Park, Mesa, AZ (US)

(21) Appl. No.: 13/362,486

(22) Filed: Jan. 31, 2012

(51) Int. Cl. A01N 25/34; A01P 7/04

(52) U.S. Cl. 424/405

(57) ABSTRACT

Unique spherically shaped insecticidal hydrogel feeding spheres are described comprising insecticide active, food source, optional adjuvant, water, and super-absorbent polymer. The large discrete spheres with diameters of about 2 mm to about 6 mm are made possible by the use of coarse dry granulated polyacrylamide/acrylates copolymer having particle size of from about 1 mm to about 4 mm. The insecticidal hydrogel bait spheres may be placed out in the environment to control insects without the need for a bait station enclosure. The present invention also comprises a method for producing the large discrete bait spheres.

### FIELD OF INVENTION

The present invention relates in general to insecticidal baits and in particular to a spherical form of insecticidal bait comprising relatively large insecticidal hydrogel feeding spheres and a method for producing the spheres by hydrating a coarse dry granular super-absorbent copolymer with a water-based solution or microemulsion of insecticide and food source.

### BACKGROUND

Gelled insecticides are well known in the literature. An insecticide formulation in semisolid or solid gel form may be distributed in the environment, and generally used in ways to control pests that may not be possible or practical with powdered or liquid insecticide compositions. For example, it is well known that a controlled release of insecticidal actives, such as a slow-timed release, is possible by formulating an insecticide active into a gel matrix.

Gel ant baits are a common way to achieve nest kill by providing both a food source together with a slow-acting insecticidal active such that the ants or roaches feed and bring the actives back to the nest. Gelled baits are convenient because of the spill proof nature of a polymer gel matrix, making this physical form ideal for incorporation in plastic bait stations that necessarily have open access ports, and into syringes for safe consumer application. Some of the more relevant art in this area is discussed below.

U.S. Pat. No. 7,138,367 (Hurry et al.) discloses the combination of super-absorbent polymer (SAP) and volatile liquids such as fragrances to create gels usable for air freshening. The disclosure indicates that the volatile liquid may be an insecticide.

PCT Application Publication No. WO 91/07972 (Dykstra et al.) discloses an insecticide dispersed within in a solid gel matrix comprising carrageenan.

U.S. Pat. Nos. 4,818,534; 4,983,390; 4,983,389; 4,985,251; and 5,567,430, and PCT Application Publication WO89/012450 (each to Levy), disclose the gellation of insecticides, pesticides, herbicides, and the like with super-absorbent polymers to form solid or flowable formulations. For example, a flowable gel may be distributed across the surface of a pond for mosquito control. In the Levy disclosures, the super-absorbent polymer is in powder or flake form, adapted to be blended and/or agglomerated.

The examples in the literature teach controlled release of active material from a polymeric matrix. That is, the purpose of formulating an insecticide, attractant, or other biological active into a gelled mass is that the active evaporates from the polymer matrix at a controlled and predictable rate. The gelled bait examples show how a gelled mass provides a spill-proof physical form for bait when used inside a bait station or in a syringe applicator.

With that said, what is still lacking in the industry are other forms of gelled insecticidal baits, besides solid amorphous masses, which retains sufficient amounts of water and food to promote continuous and direct feeding by insects over extended periods of time. In particular, there are no practical options for formulating an insecticidal bait product into a physical form that may be easily placed in and around homes and in the environment without the need for a bait station or other structure to contain it.

### SUMMARY OF THE INVENTION

It has now been discovered that by hydrating super-absorbent polymer granules of coarse particle size with stable aqueous insecticidal bait solutions or microemulsions, large optically transparent hydrogel feeding spheres may be produced. These large hydrogel spheres retain the insecticidal bait solution for extended periods of time and have relatively equal feeding consumption compared to gel bait such as those used in a bait station. Unexpectedly, the spheres remain entirely intact and transparent as they are consumed by feeding insects over time. The hydrogel spheres function as feeding spheres, decreasing in weight as the liquid food source is extracted out from the matrix.

In one preferred embodiment of the present invention, a polyacrylamide/acrylates copolymer in the form of coarse dry granules having average particle size of from about 1 mm to about 6 mm is combined with a stable aqueous insecticidal bait solution to form stable, optically transparent, insecticidal hydrogel bait spheres.

In another preferred embodiment of the present invention, a polyacrylamide/acrylates copolymer in the form of coarse dry granules having average particle size of from about 1 mm to about 4 mm is combined with a stable insecticidal bait microemulsion to form stable, optically transparent, insecticidal hydrogel bait spheres having diameters from about 0.2 cm to about 0.6 cm.

In another preferred embodiment of the present invention, a method of forming optically transparent hydrogel feeding spheres is provided, said method comprising the steps of producing a solution or microemulsion of insecticide active and/or bait, and adding the stable insecticidal/bait solution or microemulsion to dry, coarse super-absorbent polymer granules, and allowing the hydrogel spheres to form.

In another preferred embodiment of the present method, an polyacrylamide/potassium acrylate copolymer in the form of coarse dry granules having average particle size from about 1 mm to about 6 mm is combined with a stable insecticidal bait solution or microemulsion comprising an insecticide active, a food source, water, optional solvent, and optional emulsifier, to form hydrogel feeding spheres with diameters ranging from 2 mm to 1 cm, and having greater than 20% light transmission at wavelengths above 400 nm, greater than 25% light transmission at wavelengths above 500 nm, and greater than 30% light transmission at wavelengths above 700 nm.

### DETAILED DESCRIPTION OF THE INVENTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the relative amounts of the ingredients of the inventive compositions and in the conditions of the manufacturing method described without departing from the scope of the invention as set forth in the appended claims. Most importantly, changes in shape and size of the swelled insecticidal hydrogel feeding spheres or changes to the size distribution of the spheres do not depart from the intended scope of the invention. Furthermore, changes to the order of addition of the ingredients, or changes to the temperatures and time of mixing do not depart from the intent of the invention.

That said, the present invention relates to insecticidal bait in the form of large diameter discrete swelled spheres and is distinguished from the prior art that discloses amorphous polymer gel insecticide and insect bait. In addition to the super-absorbent polymer, the insecticidal feeding spheres of the present invention comprise at least one insecticide active, at least one food source, optional adjuvant, and water as components of the hydrogel. The insecticidal hydrogel bait spheres herein are comprised of a super-absorbent polymer or copolymer (often abbreviated in the art as SAP) and an aqueous insecticide and bait solution or emulsion. As will be described in detail below, it is desirable to first produce a stable aqueous solution or emulsion of insecticide active and food source and then to combine the liquid solution or emulsion with a dry granular SAP having very specific and defined granulometry in order to produce insecticidal hydrogel bait spheres having the desired size, stability, and optical transparency.

In another embodiment of the present invention, a method of manufacturing comprises the steps of (1) mixing all the ingredients minus the SAP together to form an aqueous insecticidal bait solution or microemulsion; (2) then mixing the clear liquid solution or microemulsion with the granular SAP; and (3) allowing a sufficient period of time for hydration of the granules and formation of the large swelled spheres. It is irrelevant if the insecticidal bait solution or microemulsion is poured on top of the dry SAP granules or if the SAP granules are dropped, sifted, etc. into the solution or emulsion. However, depending on the characteristics of the container in which the hydration of the SAP granules is to take place (e.g. if the container is made of PET or other plastic), the SAP granules may tend to have an electrostatic interaction with the plastic if dropped into a dry container. The remedy for controlling the behavior of the SAP granules within the container is to add the liquid solution or mixture into the container first and then add the SAP granules to the liquid filled container. It may be desirable to package the hydrating, or already hydrated, feeding spheres in a plastic container that can be adapted by the end-user into a bait station, for example by opening up previously sealed access ports.

Herein, “transparency” is a term used qualitatively and only subjectively, and is meant to convey a characteristic seen by comparing opaque solid or semisolid insecticidal gel with the large and discreet insecticidal hydrogel feeding spheres disclosed herein, produced by the present method. The present spheres appear by the naked eye to be “more transparent” than a mass of semisolid or solid gel. In other words, use of the terms “transparent,” “clarity,” “optical clarity,” or “optical beauty” herein, is only meant to convey that the product manufactured by the present method appears clear and not opaque when visually inspected. However, for the transparency in accordance with the present invention to be communicable, light transmittance percentage (% T) versus wavelengths of incident light for swelled, insecticidal hydro gel bait spheres produced by the present method is easily measured and plotted. Surprisingly, the measured % T plots for the preferred bait spheres with optical clarity are considerably less than one would expect (e.g., never exceeding 35% T from 350-900 nm) considering the swelled hydrogel spheres produced herein look so much more optically appealing than a bulk mass of semisolid or solid insecticidal gel.

### Super Absorbing Polymer

The polymer according to the present invention, to be mixed with the insecticidal bait solution or microemulsion, is preferably a super-absorbent material, and more specifically a super-absorbent polymer or SAP. These are materials that are capable of absorbing large amounts of water or aqueous solutions are thus referred to in the art as “hydrogel-forming” SAP's. In the context of the present invention, super-absorbents are synthetic organic polymers or copolymers that may be linear, branched, and optionally cross-linked. Preferred SAP's may contain acrylic acid, methacrylic acid, acrylamide, acrylic esters, and/or methacrylic esters as monomers, and may be homopolymers of any of the above-mentioned monomers. Alternative, the SAP's may be copolymers through combinations of acrylates, acrylamides, methacrylates, acrylic acid or methacrylic acid, or copolymers of any of these monomers with vinyl acetate, vinyl alcohol, maleic anhydride, or isobutylene-maleic anhydride. The SAP's may also be saponified graft polymers of acrylonitrile or graft polymers of starch and acrylic acid, polyvinyl alcohol, polyvinylpyrrolidone, polyvinyl alkyl ether, polyethylene oxide, polyacrylamide, and copolymers thereof, or their salts. In any case, such SAP's as those described above are capable of absorbing between about 50 and 200 times their own weight of water or hydrophilic solvent. The most common SAP's include the cross-linked sodium polyacrylate/polyacrylic acid polymers, at least for use in diapers where rapid absorption of liquids having high electrolyte content is required. Super-absorbents of this type are commercially available under the names Salsorb® (Ciba/Allied Colloids, Ltd.) and Cabloc® (Stockhausen, GmbH). Other SAP's that may find use in the present invention include, but are not limited to, the hydrogel-forming polymers set forth in U.S. Pat. Nos. 7,528,291; 7,504,551; 5,669,894; 5,559,335; 5,539,019; 5,250,642; 5,196,456; 5,145,906; 4,507,438; and, 4,295,987; and, in U.S. Pat. Application No. 2007/0185228, all incorporated herein by reference.

However, the most preferred super-absorbing polymers for use in the present invention are copolymers containing acrylamide and acrylic acid salt monomers, sometimes referred to as polyacrylamide/acrylates SAP. These copolymers may be alternating copolymers, random copolymers, block copolymers, or graft copolymers. They may be linear or branched, and optionally cross-linked. Particularly preferred polymers include: polyacrylamide/sodium acrylate cross-linked copolymer (CAS No. 25085-02-3) sold by Aekyung Specialty Chemicals Co, Ltd under the trade name Hisobead®, and by Stockhausen, GmbH under the trade name Praestol®, amongst other domestic and international suppliers; a copolymer of starch, with grafted side chains of copolymers of acrylamide and sodium acrylate, sold by Grain Processing Corporation under the trade name Water Lock® A-100; and, polyacrylamide/potassium acrylate cross-linked copolymer (CAS No. 31212-13-2) sold by Horticultural Alliance, Inc. under the trade name Horta-Sorb®, by Stockhausen, GmbH under the trade name StockSorb®, and by Novo-Tech, Inc. under the trade name Water Keep®, amongst other domestic and international suppliers. “CAS No.” refers to the identification number assigned by the Chemical Abstracts Service, which orchestrates a globally recognized identification system for chemical compounds and assigns unique identifiers to each and every chemical substance known. The CAS No. is particularly important when distinguishing between SAP's because these materials, often having abbreviated, creative trivial names and/or brand names, are easily confused. Without question the most preferred SAP herein is the cross-linked polyacrylamide/potassium acrylate copolymer identified by CAS No. 31212-13-2 because this particular SAP consistently produces clear hydrogel spheres provided that the granular SAP is supplied within a defined large granulometry and provided it is combined with a stable aqueous insecticidal bait composition. Use of the sodium salt of the SAP (namely CAS No. 25085-02-3) gives a more opaque and less preferred hydrogel sphere although these spheres are equally useful as insecticidal bait.

The super-absorbent polymers/copolymers for use in the present invention, regardless of comprising sodium or potassium acrylate monomers, must be obtained in the form of a dry, coarse granulate with average particle size of from about 1 mm to about 6 mm, and preferably 1 mm to 4 mm, such that visibly large and discrete hydrogel spheres result upon admixture of the granulate with the aqueous solution or microemulsion and after sufficient time is allowed for full absorption of liquid by the SAP. Finely powdered SAP is well known in the insecticide art and has been used to produce gelled insecticidal baits. However, powdered SAP produces an amorphous solid gel mass resembling tapioca or mush, with no discernable spherical structure, and this amorphous gel will require some sort of secondary containment for use and handling (a syringe tube, or a bait station). Therefore, it is most preferred to use a dry granulated SAP with a large enough average particle size such that the resulting hydrated spheres have a diameter distribution of from about 2 mm up to about 1 cm, and that is achieved by use of a dry granulate SAP having particle size of from about 1 mm to about 6 mm. Large spheres allow easy handling, for example simple dispensing from an open pouch by hand or with forceps. Most preferred is to begin with coarse SAP particles with diameters about 1 mm to about 4 mm in order to produce hydrogel spheres having diameters from about 2 mm to about 6 mm, (0.2 cm-0.6 cm), and it is always preferred to not have “fines.” With the preferred overall SAP particle sizes of from about 1 mm to about 4 mm, the absorption of the insecticidal bait solution or microemulsion by the SAP granulate typically takes between 12 and 42 hours at room temperature. The SAP and insecticidal bait solution or microemulsion may of course be combined in the containers in which the bait product is to be merchandised, and these containers may be boxed up in corrugate for shipment even without waiting for full hydration of the spheres. Certainly by the time the product reaches any store for merchandising and sale, the hydration process would be long since completed.

For optimal clarity and esthetics of the hydrated bait spheres, and for ease and convenience of use by the end-user, complete polymer hydration should be targeted. That is, there should not be an excess of liquid, or an insufficient amount of liquid, when hydrating the polymer granules. For this balance to be achieved, it is preferred to use from about 0.5% to about 3.0% by weight of the SAP granules to total weight of the final composition. If too much SAP is used in relation to the amount of insecticidal bait solution or microemulsion, the spheres will have an opaque core, appearing to contain a seed or nucleus inside of the relatively clear swollen hydrogel sphere. As mentioned, if too little SAP is used in relation to the insecticidal bait solution or microemulsion, the extra solution or microemulsion will not be absorbed by the SAP and it will remain in the merchandising container sloshing around with the hydrogel spheres, seriously destroying the ease of handling of the product and potentially leading to leakage outside the packaging. In the present method, the preferred amount of SAP to total composition is from about 0.5% to about 3.0%, more preferred is SAP from about 1.0% to about 2.0%, and most preferred is SAP from about 1.4% to about 1.8% by weight in the total composition. As explained in the formula table below, the remainder of the total weight of composition is the insecticidal bait solution or microemulsion. Thus, if the most preferred level of 1.8% by weight SAP is used in the method, 98.2% by weight is the insecticidal bait solution or microemulsion.

### Insecticidal Bait Solutions and Emulsions

As discussed, the present invention comprises large swelled hydrogel spheres comprising super-absorbent polymer hydrated by an insecticidal bait solution or microemulsion. These solutions/emulsions include at least one insecticide active, at least one food source (i.e. bait), and water. The solutions or emulsions may additional comprise emulsifiers, solvents, dyes, embittering agents, stabilizers, and preservatives.

Insecticidal Actives:

The insecticidal active for use in the present invention is potentially unlimited. For one reason, the spheres may be used to eradicate and control any type of crawling or flying pests. The second reason for the wide scope of useful insecticides is that even if the insecticide active(s) is/are not readily soluble in water, it/they can always be emulsified into water with one or more emulsifiers and/or one or more solvents to produce an emulsion that can be used subsequently to hydrate the super-absorbent polymer granules. With that being said, preferred actives may be chosen from the group consisting of Bacillus (e.g. Bacillus thuringiensis); Bacillus endotoxins (e.g. Bacillus thuringiensis delta-endotoxin); carbamates; chitin synthesis inhibitors; cholinesterase inhibitors; cyclodiene insecticides; ecdysone agonists; GABA-regulated chloride channel blockers; GABA antagonists; juvenile hormone mimics; macrocyclic lactones; lipid biosynthesis inhibitors; mitochondrial electron transport inhibitors (METI); molting inhibitors; naturally occurring or a genetically modified viral insecticides; neonicotinoids; nereisotoxin analogs; neuronal sodium channel blockers; nicotinic receptor agonists/antagonists compounds; octopamine receptor ligands; oxidative phosphorylation inhibitor compounds; pyrethroids; ryanodine receptor ligands; sodium channel modulators; uncoupler compounds; ureas; and mixtures thereof.

Within these preferred groups based on mode of action, a number of specific insecticide actives are useful for inclusion within the hydrogel feeding spheres of the present invention. These insecticides are preferably selected from the group consisting of: (1) Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon; (2) Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate; (3) Pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluvalinate, tefluthrin, tetramethrin, tralomethrin, transfluthrin; (4) Growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen; (5) Nicotinic receptor agonists/antagonists compounds: clothianidin, dinotefuran, imidacloprid, thiamethoxam, nitenpyram, acetamiprid, thiacloprid; (6) GABA antagonist compounds: acetoprole, endosulfan, ethiprole, fipronil, vaniliprole; (7) Macrocyclic lactone insecticides: abamectin, emamectin, milbemectin, lepimectin, spinosad; (8) METI (mitochondrial electron transport inhibitor) I acaricides: fenazaquin, pyridaben, tebufenpyrad, tolfenpyrad; (9) METI II and III compounds: acequinocyl, fluacyprim, hydramethylnon; (10) Uncoupler compounds: chlorfenapyr; (11) Oxidative phosphorylation inhibitor compounds: cyhexatin, diafenthiuron, fenbutatin oxide, propargite; (12) Molting disruptor compounds: cryomazine; (13) Mixed function oxidase inhibitor compounds: piperonyl butoxide; (14) Sodium channel blocker compounds: indoxacarb, metaflumizone; (15) Miscellaneous insecticides: boric acid, sodium tetraborate pentahydrate (borax), benclothiaz, bifenazate, cartap, flonicamid, pyridalyl, pymetrozine, sulfur, thiocyclam, and malononitrile compounds as described in JP 2002 284608, WO 02/89579, WO 02/90320, WO 02/90321, WO 04/06677, WO 04/20399, or JP 2004 99597; and mixtures thereof.

The most preferred insecticide actives for use herein are selected from the group agent is selected from the group consisting of abamectin, acephate, acetamiprid, acetoprole, amidoflumet, avermectin, azadirachtin, azinphos-methyl, bifenthrin, bifenazate, bistrifluoron, boric acid, buprofezin, carbofuran, cartap, chlorfenapyr, chlorfluazuron, chlorpyrifos, chlorpyrifos-methyl, chromafenozide, clothianidin, cyflumetofen, cyfluthrin, beta-cyfluthrin, cyhalothrin, lambda-cyhalothrin, cypermethrin, cyromazine, deltamethrin, diafenthiuron, diazinon, dieldrin, diflubenzuron, dimefluthrin, dimethoate, dinotefuran, diofenolan, emamectin, endosulfan, esfenvalerate, ethiprole, fenothiocarb, fenoxycarb, fenpropathrin, fenvalerate, fipronil, flonicamid, flubendiamide, flucythrinate, tau-fluvalinate, flufenerim, flufenoxuron, fonophos, gamma-cyhalothrin, halofenozide, hexaflumuron, hydramethylnon, imidacloprid, indoxacarb, isofenphos, lufenuron, malathion, metaflumizone, metaldehyde, methamidophos, methidathion, methomyl, methoprene, methoxychlor, methoxyfenozide, metofluthrin, monocrotophos, nitenpyram, nithiazine, novaluron, noviflumuron, oxamyl, parathion, parathion-methyl, permethrin, phorate, phosalone, phosmet, phosphamidon, pirimicarb, profenofos, profluthrin, protrifenbute, pymetrozine, pyrafluprole, pyrethrin, pyridalyl, pyrifluquinazon, pyriprole, pyriproxyfen, rotenone, ryanodine, S1812 (Valent), sodium tetraborate pentahydrate (borax), spinosad, spiridiclofen, spiromesifen, spirotetramat, sulprofos, tebufenozide, teflubenzuron, tefluthrin, terbufos, tetrachlorvinphos, thiacloprid, thiamethoxam, thiodicarb, thiosultap-sodium, tolfenpyrad, tralomethrin, triazamate, trichlorfon, triflumuron, aldicarb, imicyafos, fenamiphos, amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad, Bacillus thuringiensis aizawai, Bacillus thuringiensis kurstaki, Bacillus thuringiensis delta endotoxin, baculovirus, entomopathogenic bacteria, entomopathogenic virus, entomopathogenic fungi, and mixtures thereof.

The total amount of insecticidal active used in the hydrogel bait sphere composition depends on the target pests and their environment, the nature of the pesticide active, whether or not a mixture of actives is used, and if there is a synergistic enhancement of insecticidal activity when using combinations of actives. Typically, any of the above mentioned active(s) may be incorporated into the swelled bait spheres from trace amounts (e.g., 0.0001 wt. % or less) up to about 5 wt. %, based on the total weight of the spheres (liquid plus SAP). More preferred is that the insecticidal active not exceed about 0.1% unless the active is an inorganic substance such as boric acid or borax. Most preferred is to use dinotefuran at from about 0.01 to about 0.10 wt. %; chlorfenapyr at from about 0.01 to about 0.10 wt. %; spinosad at from about 0.01 to about 0.05 wt. %; indoxacarb at from about 0.01 to about 0.10 wt. %; avermectin at from about 0.005 to about 0.02; fipronil at from about 0.0001 to about 0.01 wt. %; hydramethylnon at from about 0.10 to about 0.30 wt. %, or boric acid or borax at from about 0.50 to about 5.0 wt. %, or mixtures of any of these substances in any combination. These latter preferred materials at the levels mentioned will produce ant feeding spheres useful for the control and kill of ant populations.

Food Source (bait)

The hydrogel feeding spheres of the present invention necessarily comprise at least one food source (i.e. bait) to attract crawling and/or flying insects. Such foods are disclosed in U.S. patent application 2009/0304624 (Gutsmann) and U.S. Pat. Nos. 6,162,825; 5,925,670; 5,906,983; and 5,547,955 (each to Silverman, et al.), each incorporated herein by reference. Typically, insect baits tend to comprise small molecular weight sugars, moderate molecular weight oligosaccharides, larger molecular weight carbohydrates, grain foods, lipids, fats, hydrogenated fats, or animal or vegetable proteins, or mixtures of these various foods depending on the targeted pest(s) and the desired physical form of the finished bait. Sugar baits may comprise any mono- or disaccharide, any type of reduced sugar (sugar alcohols), derivatives of sugars (e.g. sugar amines) or polyhydroxy alcohols, molasses, and/or any of the known sugar syrups and jams. Most commonly found foods in insect baits, and those that find use in the bait spheres of the present invention, include, but are not limited to, glucose, fructose, sucrose, dextrose, maltose, lactose, galactose, arabinose, glycerin, invert sugar, molasses, high fructose corn syrup, maple syrup, honey, hydrogenated vegetable shortening, black sugar, brown sugar, glucosamine, and vegetable oil. The food source is preferably incorporated into the hydrogel bait sphere composition at from about 1 wt. % to about 70 wt. % depending on the targeted pests. For example, spherical ant baits in accordance with the present invention may comprise from about 1 wt. % to about 70 wt. % of a mixture of various sugars and syrups such as sucrose, dextrose, and high fructose corn syrup. Most preferred is to use a combination of sugars and syrups at a total weight of from about 10 wt. % to about 60 wt. %, based on the total weight of the insecticidal bait sphere composition (liquid plus SAP). When the desired insect bait is not soluble in water, such as for example the case with vegetable oil or shortening, the food may be emulsified into the water with at least one emulsifier and/or solvent in the same way that an insoluble insecticide may be emulsified into water, (detailed below).

Insecticide Microemulsions

As mentioned, any insecticidal active known in the pesticide arts will suffice for inclusion in the bait spheres of the present invention because even if the insecticide does not dissolve in water, the active or actives can be emulsified into water with at least one emulsifier and/or at least one solvent besides water. Ideally, emulsification of the water-insoluble insecticide active(s) into water will preferably achieve a transparent “microemulsion,” although it is conceivable that even a turbid emulsion (one of larger droplet size) can still be used to hydrate the SAP granules. Stable microemulsions, which necessarily appear transparent, seem to produce bait spheres having greater optical transparency. Therefore, if optically clear hydrogel bait spheres are desired, it is preferred to find a system of emulsifiers and/or solvents that can create the stable microemulsion rather than a turbid O/W emulsion.

With that said, the formation of a stable aqueous insecticidal microemulsion typically requires the proper selection of surfactants/emulsifiers, sometimes supplemented with other co-emulsifiers and/or various solvents. In the context of fragrance microemulsions (i.e., hydrophobic essential oil(s) emulsified into water), U.S. Pat. Nos. 7,226,901 (Stora); 6,403,109 (Stora); 6,071,975 (Halloran); and 5,374,614, (Behan et al); U.S. Application Publication 2002/0143072 (Aust); and, PCT Application Publication WO2005/123028 (Piechocki, at al) are instructive and incorporated herein by reference. The methods described for the formation of stable fragrance microemulsions may be extrapolated to insecticide microemulsions when the insecticide has poor to no solubility in water (i.e. too hydrophobic). A microemulsion means a single or one-phase transparent, thermodynamically stable, mixture of two or more immiscible liquids and one or more surfactants/emulsifiers. Microemulsions are generally visibly clear or transparent, because they contain structures smaller than the wavelength of visible light, which is typically around 500 nm A microemulsion contains structures that are spontaneously self-assembling aggregates, (i.e., “thermodynamically controlled” and not “kinetically controlled”), consisting of oil and surfactant monolayers, or water and surfactant monolayers. A microemulsion may contain oil droplets dispersed in water (O/W), water droplets dispersed in oil (W/O), or a bi-continuous structure or other structure. It will be optically clear to the naked eye because the incident light is not reflected by the small droplets of the dispersed phase. In the present invention, the oil phase is the insecticide active(s) or the active(s) dissolved in a water-immiscible co-solvent, which will be discussed in detail below. Herein, a relatively small amount of insecticidal active may be dispersed into water to produce clear O/W microemulsions with the aid of one or more surfactants/emulsifiers and/or co-solvents.

Below we describe some of the preferred emulsifiers, stabilizers and solvents that may be used to achieve a stable microemulsion for use in the present invention. The preferred emulsification system is comprised entirely of nonionic emulsifiers and no alcohol or other volatile solvents, in order to obtain the optical beauty of the finished hydrogel bait spheres. The present invention may require the use of a mixture of several different emulsifiers to achieve a stable microemulsion. However, depending on the hydrophobicity of the insecticidal active, it may be possible to achieve a stable microemulsion by simply using one emulsifier. Other actives require tricky combinations of several emulsifiers and possibly solvents to achieve stable, clear microemulsions. The important point is that selection of emulsifers, stabilizers, etc., is a somewhat empirical process and is without question dependent on the nature, particularly the hydrophobicity, or the insecticide active.

Nonionic Emulsifier

The nonionic emulsifier for use in the present method of production and bait composition may comprise at least one nonionic material including: sorbitan esters; alkoxylated sorbitan esters; C₂-C₆ glycols; glycol esters; glycerin; glyceryl esters; alkoxylated glyceryl esters; amide waxes; fatty alcohols; monoalcohol esters; polyethylene glycol, polyethylene glycol esters; polypropylene glycol, polypropylene glycol esters, fatty alcohol alkoxylates; alkyl phenol alkoxylates; alkoxylated fatty acid esters; and other nonionic materials of surfactant classification (e.g. alkanolamides, amine N-oxides, alkylpolyglycosides, etc.), and mixtures thereof. Regardless of the nature of the nonionic material(s), it is preferred to use a total amount of nonionic emulsifier at from about 0.0002% to about 0.2% by weight, based on the total weight of the finished spheres (liquid plus SAP).

Preferred nonionic emulsifiers for use herein include the sorbitan derivatives such as the Span®, Brij®, Tween® and Atlas® products available from Croda (formerly Uniqema). These materials are sorbitan esters generally comprising a fatty acid chain, the sorbitan linkage, and optionally an alkoxylate (e.g. polyoxyethylene, also termed “PEG”, or “EO”) chain. The more preferred nonionic emulsifier for use in the present invention includes the sorbitan esters, in particular 3-80 mole ethoxylated mono-, di-, or tri-fatty acid esters of sorbitan. These materials are available under the trade name of Tween® and Atlas® from Croda and include: polyoxyethylene (2) sorbitan monolaurate (Tween® 20); polyoxyethylene (4) sorbitan monolaurate (Tween® 21); polyoxyethylene (20) sorbitan monopalmitate (Tween® 40); polyoxyethylene (20) sorbitan monostearate (Tween® 60); polyoxyethylene (4) sorbitan monostearate (Tween® 61); polyoxyethylene (20) sorbitan tristearate (Tween® 65); polyoxyethylene (5) sorbitan monooleate (Tween® 81); polyoxyethylene (20) sorbitan monooleate (Tween® 80); polyoxyethylene (20) sorbitan trioleate (Tween® 85); and, polyoxyethylene (80) sorbitan monolaurate (Atlas® G-4280), and mixtures thereof. The sorbitan esters (i.e., non-alkoxylated) are also useful, and are available under the trade name Span® from Croda. These preferred nonionic materials include sorbitan monstearate (Span® 60); and, sorbitan tristearate (Span® 65). Most preferred is to use Tween® 20, Tween® 60 and/or Tween® 80, or mixtures thereof to create the stable insecticidal microemulsion at from about 0.0002% to about 0.2% by weight based on the total weight of the finished spheres (liquid plus SAP).

Other preferred nonionic emulsifiers for use herein include surfactants such as ethoxylated (EO), propoxylated (PO), or mixed ethoxylated/propoxylated (EO/PO) alkylphenol ethers; EO, PO or EO/PO C₄-C₁₆ fatty alcohols; EO, PO or EO/PO mono- and di-esters of aliphatic C₄-C₁₆ carboxylic acids; EO, PO or EO/PO branched aliphatic alcohols with a main aliphatic carbon chains of C₄-C₁₆; and, EO, PO or EO/PO hydrogenated castor oils (such as the Cremophor® materials from BASF). Preferred ethoxylated aliphatic alcohols for use in the present invention are available under the trade name Tomadol® from Tomah. The most preferred ethoxylated aliphatic alcohols for use in the present invention include Tomadol® 25-12 from Tomah, which is essentially C₁₂-C₁₅ alcohol with an average 12 moles ethylene oxide, and/or Tomadol® 91-8 from Tomah, which is essentially C₉-C₁₁ alcohol with an average 9 moles ethylene oxide. The most preferred ethoxylated hydrogenated castor oil is Cremophor® RH-40, which is PEG-40-hydrogenated castor oil. Also preferred is Eumulgin® HPS from Cognis, which is a mixture of ethoxylated alcohols, EO/PO glycol ethers, and ethoxylated hydrogenated castor oil, along with the Genapol® products from Clariant. Most preferred are combinations of these ethoxylated materials fine tuned to accommodate the insecticide type to be emulsified.

Other preferred nonionic surfactants include the amine oxide surfactants. The preferred amine oxide surfactant for use in the present invention is typically a trialkyl amine N-oxide, most preferably an alkyldimethylamine N-oxide. Examples of such materials that find use in the present insecticide/bait microemulsion herein include Ammonyx® LO from Stepan, Barlox® 12 from Lonza Corporation, and Surfox® LO Special from Surfactants, Inc. These compounds are essentially aqueous or water/alcohol solutions of lauryl- or myristyl- dimethylamine oxide or blends/chain length distributions thereof. Any of these nonionic materials or mixtures thereof may be incorporated into the insecticide microemulsion at from about 0.0002% to about 0.2% by weight, based on the total weight of the finished spheres (liquid plus SAP).

Other preferred nonionic materials for use in the present method to produce insecticidal hydro gel bait spheres include the amide type nonionic surfactants, for example alkanolamides that are condensates of fatty acids with alkanolamines such as monoethanolamine (MEA), diethanolamine (DEA) and monoisopropanolamine (MIPA. Useful alkanolamides to assist in constructing a stable insecticide microemulsion for use herein include ethanolamides and/or isopropanolamides such as monoethanolamides, diethanolamides and isopropanolamides in which the fatty acid acyl radical typically contains from 8 to 18 carbon atoms. Especially satisfactory are mono- and diethanolamides such as those derived from coconut oil mixed fatty acids or special fractions containing, for instance, predominately C₁₂ to C₁₄ fatty acids. Of particular use in this method of production are mono- and diethanolamides derived from coconut oil mixed fatty acids, (predominately C₁₂ to C₁₄ fatty acids), such as those available from McIntyre Group Limited under the brand name Mackamide®. Most preferred is Mackamide® CMA, which is coconut monoethanolamide available from McIntyre. Amide surfactants, when used as the nonionic emulsifier or as a co-emulsifier in a mixture of emulsifiers, are incorporated into the insecticidal microemulsion at from about 0.0002% to about 0.2% by weight, based on the total weight of the finished spheres (liquid plus SAP).

The insecticide microemulsion to be admixed with the SAP in the present invention may also be stabilized with alkyl polyglycoside surfactant as a nonionic material. The alkyl polyglycosides (APGs) also called alkyl polyglucosides if the saccharide moiety is glucose, are naturally derived nonionic surfactants. The alkyl polyglycosides that may be used in the present invention are fatty ester derivatives of saccharides or polysaccharides that are formed when a carbohydrate is reacted under acidic condition with a fatty alcohol through condensation polymerization. The APGs are typically derived from corn-based carbohydrates and fatty alcohols from natural oils in animals, coconuts and palm kernels. The alkyl polyglycosides that are preferred for use in the present invention contain a hydrophilic group derived from carbohydrates and is composed of one or more anhydroglucose units. Each of the glucose units can have two ether oxygen atoms and three hydroxyl groups, along with a terminal hydroxyl group, which together impart water solubility to the glycoside. The presence of the alkyl carbon chain leads to the hydrophobic tail to the molecule. When carbohydrate molecules react with fatty alcohol compounds, alkyl polyglycoside molecules are formed having single or multiple anhydroglucose units, which are termed monoglycosides and polyglycosides, respectively. The final alkyl polyglycoside product typically has a distribution of varying concentration of glucose units (or degree of polymerization). The APGs that may be used in the insecticide microemulsion as the nonionic emulsifier component preferably comprise saccharide or polysaccharide groups (i.e., mono-, di-, tri-, etc. saccharides) of hexose or pentose, and a fatty aliphatic group having 6 to 20 carbon atoms. Preferred alkyl polyglycosides that can be used according to the present invention are represented by the general formula, Gₓ-O—R¹, wherein G is a moiety derived from reducing saccharide containing 5 or 6 carbon atoms, e.g., pentose or hexose; R¹ is fatty alkyl group containing 6 to 20 carbon atoms; and x is the degree of polymerization of the polyglycoside, representing the number of monosaccharide repeating units in the polyglycoside. Generally, x is an integer on the basis of individual molecules, but because there are statistical variations in the manufacturing process for APGs, x may be a non-integer on an average basis when referred to APG used as an emulsifier for the insecticide microemulsion of the present invention. For the APGs of use herein, x preferably has a value of less than 2.5, and more preferably is between 1 and 2. Exemplary saccharides from which G can be derived are glucose, fructose, mannose, galactose, talose, gulose, allose, altrose, idose, arabinose, xylose, lyxose and ribose. Because of the ready availability of glucose, glucose is preferred in polyglycosides. The fatty alkyl group is preferably saturated, although unsaturated fatty chains may be used. Generally, the commercially available polyglycosides have C₈ to C₁₆ alkyl chains and an average degree of polymerization of from 1.4 to 1.6. APG surfactants, when used as the nonionic emulsifier or as a co-emulsifier in a mixture of nonionic materials, may be incorporated into the insecticide microemulsion at from about 0.0002% to about 0.2% by weight, based on the total weight of the finished spheres (liquid plus SAP).

The insecticidal microemulsion herein may also be stabilized with polyether materials, such as ethylene glycol, propylene glycol, glycerin, polyethylene glycol or polypropylene glycol, or mixtures of these as the nonionic emulsifier. One such polyether useful in the insecticide microemulsion is polyethylene glycol (or “PEG”). These materials are most readily obtained from the Dow Chemical Company under the brand name Carbowax®. Esters of PEG may also find use in the present invention. Non-limiting examples include: PEG (40) stearate; PEG (200) cocoate; PEG (200) monooleate; PEG (300) monooleate; PEG (300) monostearate; PEG (400) cocoate; PEG (400) dilaurate; PEG (400) diooleate; PEG (400) monolaurate; PEG (400) monooleate; PEG (400) monostearate; PEG (400) ricinoleate; PEG (600) dioleate; and, PEG (600) monolaurate. The insecticide microemulsion may also utilize small molecular weigh glycols (i.e. C₂-C₆) such as ethylene glycol, propylene glycol, diethylene glycol or dipropylene glycol. Additionally, esters of these lower molecular weight glycols find use in the present invention. Some non-limiting examples include: diethylene glycol distearate; diethylene glycol monostearate; ethylene glycol monostearate; propylene glycol dioleate; propylene glycol monostearate; and, propylene glycol tricapryl caprate. Any of these glycols, glycol ethers, polyethers, and/or esters, when used as the nonionic emulsifier or as a co-emulsifier in a mixture of nonionic materials, may be incorporated into the insecticide microemulsion at from about 0.0002% to about 0.2% by weight, based on the total weight of the finished spheres (liquid plus SAP).

Additionally, mono-alcohol esters find use in the present invention to emulsify the insecticide into a stable O/W insecticide microemulsion. These materials include: 2-ethylhexyl oleate; 2-ethylhexyl palmitate; 2-ethylhexyl tallowate; 2-ethylhexyl stearate; butyl oleate; butyl stearate; cetyl palmitate; cetyl stearate; decyl oleate; isocetyl isostearate; isocetyl stearate; isopropyl myristate; isopropyl oleate; isopropyl palmitate; isopropyl palmitate-stearate; isotridecyl stearate; isodecyl stearate; myristyl myristate; and, octyl palmitate. These alcohol esters, when used as the nonionic emulsifier or as a co-emulsifier in a mixture of nonionic materials, may be incorporated into the insecticide microemulsion at from about 0.0002% to about 0.2% by weight, based on the total weight of the finished spheres (liquid plus SAP).

Lastly, glycerin, glyceryl fatty acid mono-, di-, and tri-esters, and alkoxylated fatty acid glyceryl mono-esters may be used as the nonionic emulsifier herein, either alone or mixed with other nonionic materials discussed. These well known emulsifiers include such compounds as: glyceryl monostearate, monooleate, monopalmitate, monococoate, monotallowate, monomyristate, monoricinolate and the like; polyoxyethylene-glyceryl monostearate, monooleate, monopalmitate, monococoate, monotallowate, monomyristate, monoricinoleate, and the like, where the degree of ethoxylation is from about 7 to about 80; glyceryl di-stearate, -oleate, -palmitate, -cocoate, -tallowate, -myristate, -ricinolate, and the like; and, glyceryl tri-acetate, -stearate, -oleate, -palmitate, -cocoate, -tallowate, -myristate, -ricinolate, and the like. Glycerin and these glycerin derivatives, when used as the nonionic emulsifier or as a co-emulsifier in a mixture of nonionic materials, may be incorporated into the insecticide microemulsion at from about 0.0002% to about 0.2% by weight, based on the total weight of the finished spheres (liquid plus SAP).

It should be noted that depending on molecular weight and structure, some of these nonionic materials may be solid, waxy solid or slush at room temperature. In that case, the nonionic material may be warmed in order to liquefy it before it is premixed with the water-insoluble insecticide active and/or water-insoluble food source, and then added into rapidly agitated water.

The present spherical hydrogel bait may also include one or more solvents that may be used if the stable insecticide microemulsion is otherwise not achieved with only nonionic emulsifiers. Useful solvents for a stable insecticide microemulsion include ethanol, isopropanol, n-propanol, n-butanol, MP-Diol (methylpropanediol), ethylene glycol, propylene glycol, and other small molecular weight alkanols, diols, and polyols that may assist in emulsifying the insecticide into the water and stabilizing the emulsion when used at a level of from about 0.0002% to about 0.2%. If the stable microemulsion is not obtained from use of nonionic emulsifiers in any combination, using a diol or alcohol will frequently create a clear microemulsion. Most preferred is to use propylene glycol as a co-solvent at from about 0.0002% to about 0.2% by weight, based on the total weight of the finished sphere composition (liquid plus SAP).

Water

The insecticidal hydrogel bait spheres of the present invention necessarily comprise a large amount of water. Preferably, water is present at least at 50 wt. %, and more preferably at greater than 60 wt. %, based on the total weight of the finished spheres (liquid plus SAP).

Optional Ingredients

The bait spheres of the present invention may also include optional “adjuvant” selected from the group consisting of pH adjusting agents, stabilizers, preservatives, uv-absorbing agents, dyes, pigments, antioxidants, and mixtures thereof.

The bait spheres may also include a pH adjusting agent. Such pH adjusting agents may be either alkaline or acidic and, depending on the nature of such agents, may ultimately affect the degree to which the insects are attracted to the spheres and the consumption rates. Alkaline pH adjusting agents include and organic or inorganic substance known to raise pH, such as carbonate, bicarbonate, sesquicarbonate, citrates, hydroxides, and organic amines. Acidic pH adjusting agents, used to lower the pH of the finished spheres, include such substances as mineral acids and organic acids. Organic acids are most usable for the present invention and include such substances as formic acid, acetic acid (i.e. vinegar), citric acid, malic acid, lactic acid, and the like. Aged vinegars, such as balsamic vinegars, supply both a pH acidifying agent (i.e. acetic acid) and a food source (some sugars). Any of these alkaline or acidic pH adjusting agents may be added to the bait sphere composition at about 0.0001 to about 5.0 wt %, based on the total weight of the sphere composition (liquid plus SAP), or in the amount needed to adjust the pH to form a stable hydrogel sphere that attracts insects. Most preferred is to add any form and strength vinegar at from about 0.0001 wt % up to about 1.0 wt % based on the total weight of the sphere composition.

The bait spheres of the present invention may also include various stabilizers and preservatives to help prevent microbial growth in the highly aqueous and organic rich composition of the spheres. The preferred preservatives include Dowicil®, Neolone®, and Kathon® brand products from Dow, Lonza, and Rohm & Haas. These materials are incorporated at the manufacturers' recommended levels to discourage bacterial and mold growth in the hydrogel spheres and are selected by knowing the composition and the pH of what is being preserved. Preservatives herein are meant to include antioxidants and uv-light absorbers. For example, benzoic acid, sodium benzoate, potassium benzoate, sorbic acid, sodium sorbate, potassium, sorbate, ascorbic acid, sodium ascorbate, potassium ascorbate, butylated hydroxyl toluene (BHT), or other typical food stabilizer/antioxidant may be added to the bait spheres to promote stability. If the bait spheres are colored with the incorporation of a dye, substances that absorb light and protect against dye fading (e.g. benzotriazole, benzophenone, bemotrizinol and like substances sold by BASF/Ciba under the Tinosorb® brand) may be added to the insecticidal hydrogel bait sphere composition at the manufacturers' recommended levels. Most preferred is to incorporate from about 0.01 wt. % to about 1.0 wt. % of one or more benzoate and/or sorbate salts, and Dowicil® 150 as the preservatives.

The hydrogel bait spheres may also include an embittering substance to discourage ingestion. The preferred embittering substance is Bitrex®, which may be incorporated into the bait composition at manufacturer's recommended levels.

The bait spheres of the present invention may also include dyes or other colorants to provide color to the insecticidal bait spheres and to heighten the appearance of the spheres. Such coloring may be important to aid in detecting/finding the spheres if they are laid out in the home or outside environment. Perfectly clear and colorless bait spheres may not be easy to see, and it may be advantageous to include a dye. Preferably the dyes should be water soluble, such as food dyes, and should not affect the insects' interest in visiting the bait spheres and feeding on them. Such dyes may include, but are not limited to, FD&C and/or D&C Yellows, Reds, Blues, Greens and Violets, or really any other dye. Most preferred dyes include FD&C Yellow #5 and Blue #1, and D&C Violet #2. Dyes are incorporated at levels sufficient to provide a pale color to the spheres, for example from about 0.0001% to about 0.5% by weight, based on the total weight of the composition (liquid plus SAP). Coloring the spheres allows for a “color coding” system in marketing. For example, a particular color may indicate a particular target insect and/or a particular insecticidal active (e.g. red spheres—ants; blue sphere—roaches, etc.). Batches of different colored spheres may be combined as a way to communicate to the consumer that the bait is useful against at least two pests, (for example, a mixture of blue and red spheres in a single product indicates bait that controls both ants and roaches). There is no limit to the combinations of colors when combining spheres of different colors.

The Method of Production

The method for producing the insecticidal hydrogel feeding spheres of the present invention involves combining the coarse granular SAP with either an aqueous solution of insecticide and food source, or the stable O/W insecticide microemulsion also including food source, and allowing sufficient time for formation of the discrete spheres through hydration and swelling of the SAP. The formation of the initial solution may be as simple as charging a mixing vessel with water, and with stirring or other agitation, adding the sugar and/or other food sources, the insecticide active(s), and any other desired optional ingredients such as preservatives and colorant. A clear solution may form instantly as the highly water soluble ingredients are added to the agitated water in the vessel. Of course, heating may be included to accelerate the dissolution of the water-soluble ingredients. If the insecticide active(s) and/or food source(s) are not readily soluble in water, then at least one emulsifier and/or at least one co-solvent may be added as a way to make a stable insecticide/bait microemulsion. The insecticide/bait microemulsion may be prepared by first mixing the emulsifier(s) and/or solvents with the insecticide active(s) and/or insoluble food(s) to form a premix, and then adding that premix to the water that already contains the dissolved water-soluble food sources such as sugars, any additional solvent or adjuvant such as the dyes, pH adjusting agents, and preservatives. The formation of the insecticidal O/W microemulsion may be conducted at ambient temperature or at elevated temperatures. Depending on the insecticide and/or food hydrophobicity and the necessary combination of emulsifiers and solvents required for thermodynamic stability, formation of the microemulsion may comprise the steps of: premixing the insecticide and/or food with the nonionic surfactants/emulsifiers (with any nonionic pastes or waxy solids pre-melted into liquids); dissolving sugars and other water-soluble food sources, dyes, pH adjusting agents, preservatives, and additional solvent such as propylene glycol into the water; then rapidly stirring/agitating the water phase while slowing adding in the insecticide/nonionic premix phase. Some of this order of addition is not critical, but what is almost always required is that the insecticide and/or insoluble food source(s) and at least one of the emulsifiers are premixed and that the resulting premix is added relatively slowly (even drop-wise) to the rapidly stirred water held either at room temperature or at elevated temperature. For example, the insecticide may be premixed with only alcohol ethoxylate nonionic surfactants and then that premix added to rapidly agitated water that contains another emulsifier and/or co-solvent such as an alkyl dimethyl amine N-oxide surfactant and/or a glycol. If the water or water/emulsifier, or water/solvent/emulsifier solution is warmed before the insecticide/nonionic premix is added, the temperature of the water or aqueous solution is preferably held at from about 25° C. to about 60° C. Agitation may be of any degree of force, from simple stirring with a paddle-blade up to high-shear mixing with a Ross homogenizer, or disperser. As mentioned, adjuvant such as dyes and preservatives may already be in the water phase into which the insecticide/nonionic premix is added, or these substances can just as easily be added after the insecticide/bait premix has already been added to the water phase. If solvent such as an alcohol or diol is necessary, it is usually premixed with the water prior to the addition of the insecticide/nonionic premix, although for some insecticide types, the co-solvent may be added to the insecticide/nonionic premix, or even to the turbid mixture resulting after the addition of the insecticide premix to the water phase. If the water was held at an elevated temperature during addition of the insecticide/nonionic premix, the common practice is to allow the final emulsion to come to room temperature to ensure that a stable, clear microemulsion resulted. As is well known in the art, stable microemulsions form when thermodynamically set to do so, and thus they may begin cloudy but can clarify over time if the kinetics of formation of the microemulsion are slow but the thermodymamics are favorable. Obviously if the insecticide has separated out from an initially turbid emulsion, the microemulsion is doomed and no length of time will likely cure it, meaning the emulsifier type(s) and/or amount(s) of emulsifier(s) were not optimized in the first place.

Once having either the clear solution of water-soluble ingredients, or the clear and stable insecticide/bait microemulsion, the SAP granules are placed into a suitable container (preferably the internal reservoir of a bait station, a plastic or glass jar, or even a pouch or other bag, whatever may become the merchandizing unit of sale), and the liquid is poured on top. If static electricity becomes an issue, (e.g. as seen when SAP granules are placed in perfectly dry PET plastic containers), the insecticide microemulsion may be added first to the container followed by the SAP granules. Static charges may cause the SAP granules to literally jump out from a wide-mouth container, plastic-lined pouches, or plastic bait stations, which seriously interfere with an automated filling line process. As an example of a merchandisable product, 4 grams of SAP granules may be added to small plastic wide-mouth containers along with about 100 grams of the insecticidal bait solution or microemulsion. Then each container may be closed with a screen having sufficiently sized holes to allow passage of the targeted insects. The screen allows for access to the hydrogel bait spheres by the insects while preventing the touching the product such as by children. The screen may then be covered by a threaded closure for sealing and storage. Alternatively, the hydrdated spheres can be made in bulk and then transferred from the batching vessel into these small merchandizing containers, sealable pouches, or bait stations. The absorption process may be as slow as 12-42 hours because of the size, hardness and permeability of the SAP granules and the temperature of the absorption reaction (which is normally ambient temperature in the manufacturing plant). “Sufficient time” for the SAP granules to absorb all of the insecticidal bait solution or microemulsion may be as long as 2-days. Preferably the spheres are formed from the combination of from about 0.5% to about 3% hydrogel-forming SAP granules with about 97% to about 99.5% insecticidal bait solution or microemulsion.

An exemplary bait composition of the present invention is shown in TABLE 1. Note that in this case the insecticidal active was left out, and therefore the resulting spheres are essentially just a food source/attractant for insects to feed on. The entries in TABLE 1 are weight percent (wt. %) active material.

TABLE 1
Hydrogel Feeding Spheres (without insecticide active)

| Ingredients | Wt. % |
|---|---|
| Dry granular SAP^{(1) or (2)} | 1.50 |
| Granular sucrose | 20.0 |
| High fructose corn syrup | 10.0 |
| Granular dextrose | 5.0 |
| Vinegar-300 grain | 0.30 |
| Colorants/Preservatives | 0.75 |
| Propylene glycol | 0.08 |
| Insecticide active(s) | — |
| Water | 62.37 |
| Total | 100.0 |

In TABLE 1, the dry granular SAP used was either (1) granular polyacrylamide/sodium polyacrylate (CAS 25085-02-03), or (2) polyacrylamide/potassium polyacrylate (CAS 31212-13-2), with an average particle size of about 1 mm-4 mm. Mixtures of the two copolymers would certainly work to form spheres, albeit the spheres may vary in transparency. The bait spheres produced in accordance with the composition of TABLE 1 had diameters ranging from about 0.2 cm to about 0.6 cm. These large spheres appeared optically transparent, and remarkably so when using only the potassium salt of the copolymer.

The visual clarity of the hydrogel spheres was quantified using an ultraviolet-visible spectrophotometer, HP Model 8453. Measurements of percent transmittance (% T) were recorded from 350 nm to 900 nm to cover the full visible spectrum. Hydrated bait spheres obtained from the hydration of the potassium salt of the copolymer (CAS 31212-13-2) were forced and packed into cuvettes having a pathlength of 1 cm, ensuring that contact was made throughout the cuvette by the spheres in order to have consistent incident light path lengths. The sugar bait spheres showed transmittance greater than 20% at wavelengths above 400 nm, greater than 25% transmittance at wavelengths above 500 nm and greater than 30% light transmittance at wavelengths above 700 nm.

Ant species number in the tens of thousands and vary around the country and around the world, with new species being found continuously. Some ants that may require a control in numbers or in behavior include ants from the subfamily Dolichoderinae, including the genus Dorymyrmex, Forelius, Liometopum and Tapinoma, the subfamily Formicinae, including the genus Acanthomyops, Acropyga, Camponotus, Formica, Lasius, Myrmecocystus, Paratrechina and Polyergus, the subfamily Myrmicinae, including the genus Aphaenogaster, Crematogaster, Ephebomyrmex, Formicoxenus, Leptothorax, Manica, Messor, Monomorium, Myrmecina, Myrmica, Pheidole, Pogonomyrmex, Pyramica, Rogeria, Solenopsis, Stenamma, Strumigenys, and Trachmyrmex, the subfamily Ecitoninae including the genus Neivamyrmex, the subfamily Ponerinae including the genus Amblyopone, Hypoponera and Odontomachus, and the subfamily Pseudomyrmicinae including the genus Pseudomyrmex.

At the very least, many ant species pose a nuisance problem but some species can present significant destruction in the home, including damage to wooden structures, roofs, and electrical equipment. Ants have also been known to introduce contamination and disease by spreading pathogens and some common ant species inflict painful bites. In agriculture, some ants feed on germinating seeds and crop seedlings while some domesticate and protect other pest insects that feed on crops. Examples of pest ants include but are not limited to carpenter ants (Camponotus modoc), red carpenter ants (Camponotus ferrugineus Fabricius), black carpenter ants (Camponotus pennsylvanicus De Geer), Pharaoh ants (Monomorium pharaonis Linnaeus), little fire ants (Wasmannia auropunctata Roger), fire ants (Solenopsis geminata Fabricius), red imported fire ants (Solenopsis invicta Buren), black imported fire ants (Solenopsis richteri), southern fire ants (Solenopsis xyloni), Argentine ants (Iridomyrmex humilis Mayr), crazy ants (Paratrechina longicornis Latreire), pavement ants (Tetramorium caespitum Linnaeus), cornfield ants (Lasius alienus Foerster), the odorous house ant (Tapinoma sessile Say), little black ants (Honomorium minimum), thermophilic ants (such as Forelius breviscapus and Forelius pruinosus), and ghost ants (Tapinoma melanocephalum). Thus, it is desirable to include an insecticide effective against one or more of these ant species into the hydrogel feeding spheres of the present invention.

The hydrogel spheres from TABLE 1 were tested in feeding experiments using Forelius pruinosus ants to ensure that these small ants (only 1-2 mm in length) could climb onto the large spheres (ranging from 0.2 cm to about 0.6 cm) and eat the bait as efficiently as they eat at a mass of semisolid or solid gel bait. Although not wishing to be bound to any particular theory on how the ants interact with, and feed from, the large bait spheres, it is likely that the ants consumed liquid sugar bait that continuously migrated to the surface of the spheres through interstitial pathways in the polymer matrix, like syneresis or other weeping process. However, it is important to note that the hydrogel spheres of the present invention appear uniform in cross section. That is, they can be cut in half, and each of the resulting cross sections show a uniform solid gel structure. That is, the spheres of the present invention are clearly not liquid filled capsules, since liquid filled spheres would have squirted and drained liquid when cut in half. At any rate, the small Forelius ants interacted well with the large hydrogel spheres. The small ants of only 1-2 mm in length had no problem climbing onto and feeding off of spheres that were approximately two to three times as large as themselves. Therefore, incorporation of any of the above mentioned insecticides into the bait composition of TABLE 1 will produce commercially useful insecticidal hydrogel bait spheres.

For the feeding consumption test, COMBAT® ant bait gel was prepared without active insecticide. A 2-choice test was set up for the Forelius ants using this control gel and the spheres from TABLE 1. The test was conducted in a desert wash adjacent to nests with high ant activity. Between 0.9 g and 1.1 g of the control ant gel or eight (8) of the spheres from TABLE 1 were placed on separate tight-fitting 50×9 mm Petri dish lids. At each of the seven test locations a separate Petri dish lid each containing one type of bait was placed directly on the ground next to an active ant trail. The dish lids were placed side-by-side across the trail, close to one another. Initial weights of the empty Petri dish lids and the lids with bait were recorded. Baits were left in place approximately 5 hours in the field through the middle of the day. Final weights were recorded and the percent weight loss and consumption calculated. All data were analyzed by ANOVA with replicate/location as a blocking factor. The tests showed parity in the consumption of the SAP spheres from TABLE 1 versus the Combat® ant gel base gel without insecticide active, (about 0.095 grams of the Combat® gel consumed compared to about 0.119 grams of hydrogel feeding spheres consumed). In conclusion, the small Forelius ants had no problem climbing onto the large spheres and feeding. Therefore, incorporation of any of the above mentioned insecticides into the bait composition of TABLE 1 will produce commercially useful insecticidal hydrogel bait spheres of large diameter.

We have thus described unique insecticidal bait in the form of large hydrogel spheres along with a new inventive method of production for insecticidal hydrogel spheres having optical clarity that attract feeding ants. Formation of the spheres comprises the steps of first forming an insecticidal/bait solution or stable aqueous microemulsion and then combining this liquid with super-absorbent polymer granules of relatively large granulometry. The composition of the present invention will find use as a new and convenient form of ant bait that can be simply laid out in the environment or placed inside bait stations or other suitable containers.

We claim:

1. Discrete insecticidal hydrogel feeding spheres comprising:
a. from about 1% to about 70% by weight of at least one food source;
b. from about 0.5% to about 3% by weight of an polyacrylamide/acrylates copolymer;
c. at least one insecticide active;
d. at least about 50% by weight water; and
e. optionally, adjuvant selected from the group consisting of pH adjusting agents, stabilizers, preservatives, uv-absorbing agents, dyes, pigments, antioxidants, and mixtures thereof,
wherein said spheres have an average diameter ranging from about 2 mm to about 6 mm and show greater than 20% light transmittance at wavelengths above 400 nm, greater than 25% light transmittance at wavelengths above 500 nm, and greater than 30% light transmittance at wavelengths above 700 nm.

2. The feeding spheres of claim 1, wherein said polyacrylamide/acrylates copolymer is chosen from the group of polyacrylamide/sodium polyacrylate copolymer, polyacrylamide/potassium polyacrylate copolymer, and mixtures thereof.

3. The feeding spheres of claim 1, wherein said food source is selected from the group consisting of sugars, sugar derivatives, polyhydroxy alcohols, syrups, oligosaccharides, carbohydrates, grain foods, lipids, fats, hydrogenated fats, animal protein, vegetable proteins, and mixtures thereof.

4. The feeding spheres of claim 3, wherein said food source is selected from the group consisting of glucose, fructose, sucrose, dextrose, maltose, lactose, galactose, arabinose, glycerin, invert sugar, molasses, high fructose corn syrup, honey, hydrogenated vegetable shortening, black sugar, brown sugar, glucosamine, and mixtures thereof.

5. The feeding spheres of claim 1 further including from about 0.0002% to about 0.2% by weight solvent selected from the group consisting of ethanol, isopropanol, n-propanol, n-butanol, methylpropanediol, ethylene glycol, propylene glycol, and mixtures thereof.

6. The feeding spheres of claim 1 further including at least one nonionic emulsifier chosen from the group consisting of ethoxylated alcohols, propoxylated alcohols, EO/PO alcohols, amine oxides, ethoxylated hydrogenated castor oil, ethoxylated glycols, propoxylated glycols, EO/PO glycols, ethoxylated sorbitan monooleate, ethoxylated sorbitan monolaurate, ethoxylated sorbitan monopalmitate, ethoxylated sorbitan monostearate, and mixtures thereof.

7. A method for the production of discrete insecticidal hydrogel feeding spheres of composition according to claim 1, said method comprising the steps of:
a. preparing an aqueous solution of said insecticide active, at least one food source, and any optional adjuvant by dissolving said insecticide, at least one food source and optional adjuvant into said water;
b. sourcing said polyacrylamide/acrylates copolymer in a dry coarse physical granulate form having a particle size from 1 to 4 mm; and
c. forming said discrete insecticidal hydrogel feeding spheres by combining said aqueous solution with said dry coarse polyacrylamide/acrylates copolymer and allowing sufficient time for complete hydration,
wherein said hydrogel spheres thus formed measure approximately 2 mm to 6 mm in diameter and have greater than 20% light transmittance at wavelengths above 400 nm, greater than 25% light transmittance at wavelengths above 500 nm, and greater than 30% light transmittance at wavelengths above 700 nm.

8. The method of claim 7, wherein said polyacrylamide/acrylates copolymer is chosen from the group consisting of polyacrylamide/sodium acrylates copolymer, polyacrylamide/potassium acrylates copolymer, and mixtures thereof.

9. A method for the production of discrete insecticidal hydrogel feeding spheres of composition according to claim 6, said method comprising the steps of:
a. preparing a premix of said at least one insecticide active and said at least one nonionic emulsifier;
b. preparing an aqueous solution of said at least one food source and any optional adjuvant by dissolving said at least one food source and optional adjuvant into said water;
c. adding said premix to said aqueous solution under agitation to form a stable O/W emulsion or clear microemulsion;
d. sourcing said polyacrylamide/acrylates copolymer in a dry coarse physical granulate form having a particle size from 1 to 4 mm; and
e. forming said discrete insecticidal hydrogel feeding spheres by combining said emulsion or microemulsion with said dry coarse polyacrylamide/acrylates copolymer and allowing sufficient time for complete hydration,
wherein said hydrogel spheres thus formed measure approximately 2 mm to 6 mm in diameter and have greater than 20% light transmittance at wavelengths above 400 nm, greater than 25% light transmittance at wavelengths above 500 nm, and greater than 30% light transmittance at wavelengths above 700 nm.

10. The method of claim 9, wherein said nonionic emulsifier is selected from the group consisting of C₁₂-C₁₄/12 mole EO ethoxylated alcohol, C₉-C₁₁/9 mole EO ethoxylated alcohol, lauryl dimethylamine N-oxide, PEG-40 hydrogenated castor oil, EO/PO glycol ether, and mixtures thereof.
